(19) United States
(12) Patent Application Publication
(10) Pub. No.: US 2005/0142309 A1
(43) Pub. Date: Jun. 30, 2005

(54) Multilayer structure superior in gas barrier property

(76) Inventors: Hiroaki Goto, Kanagawa (JP); Takayuki Ishihara, Kanagawa (JP); Shigenobu Murakami, Kanagawa (JP)

Correspondence Address: SHERMAN & SHALLOWAY, 415 NORTH ALFRED STREET, ALEXANDRIA, VA, 22314, US

(21) Appl. No.: 10/498,804

(22) PCT Filed: Dec. 20, 2002
(86) PCT No.: PCT/JP02/13388

(30) Foreign Application Priority Data
Dec. 25, 2001 (JP) 2001-392301
Jun. 19, 2002 (JP) 2002-178022
Nov. 19, 2002 (JP) 2002-335315

(51) Int. Cl. B28B 23/08

(52) U.S. Cl. 428/34.6

(57) ABSTRACT

A multi-layer structure with a gas barrier layer of which the oxygen permeation coefficient under a wet and heated condition is suppressed to be of a low value while maintaining excellent workability and mechanical strength. The multi-layer structure has a gas barrier layer with excellent gas barrier property, the gas barrier layer comprising a resin composition obtained by blending a thermoplastic resin having an oxygen permeation coefficient at 20° C. and 0% RH of not larger than 10⁻¹² cc·cm/cm²/sec/cmHg with a transition metal catalyst and an oxidizing organic component, said oxidizing organic component having an average diameter of dispersed particles of not larger than 1 μm as found by an area method in cross section of said gas barrier layer in the direction of thickness thereof, and an area ratio occupied by the dispersed particles being not smaller than 1% in cross section of said gas barrier layer in the direction of thickness thereof.

### BACKGROUND OF THE INVENTION

1. Field of the Invention

The present invention relates to a multi-layer structure equipped with a gas barrier member having excellent resistance against wet heated conditions and, particularly, excellent oxygen-blocking property under highly humid conditions.

2. Description of the Related Art

As packaging containers, there have heretofore been used metal cans, glass bottles and a variety of plastic containers accompanied, however, by such problems as degeneration of the content and drop of flavor due to oxygen remaining in the container or due to oxygen that enters permeating through the container walls.

In the case of the metal cans and glass bottles, no oxygen permeates through the container walls and a problem stems from only oxygen remaining in the container. In the case of the plastic containers, on the other hand, oxygen permeates through the container walls to a degree that is no longer negligible arousing a problem from the standpoint of preserving the content.

To prevent this problem, the container wall is formed in a multi-layer structure in the case of the plastic containers, and at least one layer among them is formed of a resin having oxygen-blocking property, such as an ethylene/vinyl alcohol copolymer.

In order to remove oxygen in the container, a deoxidizing agent has long been used. An example of using the deoxidizing agent in the container wall has been taught in Japanese Examined Patent Publication (Kokoku) No. 1824/1987 according to which a multi-layer structure for packaging is obtained by laminating a layer having an oxygen gas shut-off property on a layer formed by blending an oxygen-permeable resin with a deoxidizing agent comprising chiefly a reducing material such as iron powder.

Japanese Unexamined Patent Publication No. 278344/1989 proposed by the present inventors discloses a plastic multi-layer container of a laminated structure comprising layers of a humidity-resistant thermoplastic resin provided on both sides of an intermediate layer of a resin composition obtained by blending a gas-barrier thermoplastic resin having an oxygen permeation coefficient at 20° C. and 0% RH of not larger than 10⁻¹² cc·cm/cm²/sec/cmHg and a water-absorbing amount at 20° C. and 100% RH of not smaller than 0.5% with an organic metal complex of a transition metal.

International Patent Publication No. 500846/1990 discloses a barrier wall for wrapping containing a composition of a polymer having oxygen-trapping property or containing a layer of the above composition, the composition trapping oxygen by catalytically oxidizing the oxidizable organic components with a metal catalyst. As the oxidizable organic components, there have been disclosed a polyamide and, particularly, a xylylene group-containing polyamide.

A resin having excellent gas barrier property, such as an ethylene/vinyl alcohol copolymer (EVOH) exhibits very excellent oxygen shut-off property under low-humidity conditions accompanied, however, by such a problem that oxygen permeability becomes very great under high-humidity conditions.

In order to improve the content-preserving property, on the other hand, the gas barrier resin is, in many cases, used in combination with a heat-sterilizing packaging method, such as hot-water sterilization, boil sterilization or retort sterilization. During the heat-sterilization, however, the ethylene/vinyl alcohol copolymer (EVOH) is placed under high-humidity conditions not only permitting oxygen to permeate through to a large extent but also being placed in an oxygen-permeating condition even after the sterilization due to water-retaining property of the EVOH, making it difficult to obtain a desired gas barrier property.

The high gas barrier property possessed by the ethylene/vinyl alcohol copolymer is due to a high degree of hydrogen coupling possessed by this copolymer. However, the barrier effect due to the hydrogen coupling based on the hydroxyl group tends to be loosened under a condition where the water content (humidity) is acting to a high degree. This property is of an essential nature and cannot be easily improved.

### SUMMARY OF THE INVENTION

The present inventors have discovered the fact that the oxygen permeation coefficient of the multi-layer structure can be markedly improved under the wet and heated condition yet maintaining excellent workability and mechanical strength if a gas barrier layer is formed by blending a particular gas barrier resin with a transition metal catalyst and an oxidizing organic component, and if the dispersion structure and the profile structure of the oxidizing organic component are controlled to lie within particular ranges in cross section of the gas barrier layer in the direction of thickness.

It is therefore an object of the present invention to provide a multi-layer structure with a gas barrier layer of which the oxygen permeation coefficient under a wet and heated condition is suppressed to be of a low value while maintaining excellent workability and mechanical strength.

According to the present invention, there is provided a multi-layer structure having a gas barrier layer with excellent gas barrier property, said gas barrier layer comprising a resin composition obtained by blending a thermoplastic resin having an oxygen permeation coefficient at 20° C. and 0% RH of not larger than 10⁻¹² cc·cm²/sec/cmHg with a transition metal catalyst and an oxidizing organic component, said oxidizing organic component having an average diameter of dispersed particles of not larger than 1 μm as found by an area method in cross section of said gas barrier layer in the direction of thickness thereof, and an area ratio occupied by the dispersed particles being not smaller than 1% in cross section of said gas barrier layer in the direction of thickness thereof.

In the multi-layer structure of the present invention, it is desired that:
1. when the direction of thickness of said gas barrier layer is regarded to be a short axis and a direction perpendicular to the direction of thickness is regarded to be a long axis in cross section of said gas barrier layer in the direction of thickness thereof, a maximum value of an aspect ratio of dispersed particles of said oxidizing organic component represented by the length in the long axis direction/length in the short axis direction, is not smaller than 2;
2. said oxidizing organic component is a polyene polymer;
3. said oxidizing organic component is a resin having a functional group;
4. said oxidizing organic component is a resin having a carboxylic acid group or a carboxylic anhydride group; and
5. said thermoplastic resin is an ethylene/vinyl alcohol copolymer.

### BRIEF DESCRIPTION OF THE DRAWINGS

FIG. 1 is a graph plotting a relationship between the days that have passed and an increase (%) in the amount of oxygen in the container when a bottle having a multi-layer structure of propylene/gas barrier layer (20 to 25 μm thick)/polypropylene is boiled and is, then, aged at 30° C. (100% RH inside the bottle and 80% RH outside the bottle);

FIG. 2 is a scanning-type electron microphotograph of a gas barrier layer having dispersion and profile structures in cross section in the direction of thickness according to the present invention, the continuous phase being an ethylene/vinyl alcohol copolymer and the dispersion phase being a maleic acid-modified polybutadiene;

FIG. 3 is a scanning-type electron microphotograph of another gas barrier layer having dispersion and profile structures in cross section in the direction of thickness falling outside the scope of the present invention, the continuous phase being an ethylene/vinyl alcohol copolymer and the dispersion phase being a polybutadiene;

FIG. 4 is a scanning-type electron microphotograph of a further gas barrier layer having dispersion and profile structures in cross section in the direction of thickness falling outside the scope of the present invention, the continuous phase being an ethylene/vinyl alcohol copolymer and the dispersion phase being an OH-modified polyisoprene; and

FIG. 5 is a diagram illustrating the gas barrier layer of the present invention in cross section in the direction of thickness.

### EMBODIMENTS OF THE INVENTION

[Action]

A multi-layer structure having a gas barrier layer of the present invention has a feature in that a gas barrier layer is formed of a resin composition obtained by selecting a thermoplastic resin having an oxygen permeation coefficient at 20° C. and 0% RH of not larger than 10⁻¹² cc·cm/cm²/sec/cmHg as a base resin and blending it with a transition metal catalyst and an oxidizing organic component, and that the dispersion structure and the profile structure of the oxidizing organic component are controlled to lie within particular ranges in cross section of the gas barrier layer in the direction of thickness thereof.

The thermoplastic resin used in the present invention serves as a chief component, i.e., serves as a matrix of the gas barrier resin composition. The thermoplastic resin having an oxygen permeation coefficient within the above-mentioned range exhibits excellent gas shut-off property.

The invention further uses an oxidizing organic component. The oxidizing organic component exhibits the action of absorbing oxygen as it is oxidized by the action of a transition metal catalyst that will be described later.

It is considered that the oxidizing organic component easily pulls out a hydrogen atom at a position of an active carbon atom in the resin to thereby generate a radical. The composition containing the transition metal catalyst and the oxidizing organic component absorbs oxygen through the oxidation of the organic component, as a matter of course. It is believed that the oxidation occurs through the reactions, i.e., (1) generation of radicals as the hydrogen atoms are pulled out from the carbon atoms by the transition metal catalyst, (2) generation of peroxy radicals as oxygen molecules are added to the radicals, and (3) pulling out of hydrogen atoms by peroxy radicals.

In the gas barrier resin composition used in the present invention as described above, the gas barrier thermoplastic resin plays the role of shutting off the gas without being substantially oxidized. The oxidizing organic component, on the other hand, plays the role of absorbing oxygen by oxidation. Thus, the gas shut-off property and the oxygen absorbing property are exhibited as separate functions creating a distinguished feature.

As described already, if once put to the wet and heated condition, the gas barrier resin such as ethylene/vinyl alcohol copolymer loses the gas barrier property to a large extent. On the other hand, the gas barrier layer having a fine dispersion structure and a multi-layer profile structure obtained by blending the ethylene/vinyl alcohol copolymer with a transition metal catalyst and an oxidizing organic component, exhibits an unexpected effect of maintaining the oxygen permeation coefficient on an excellent level even after having been put to the wet and heated condition.

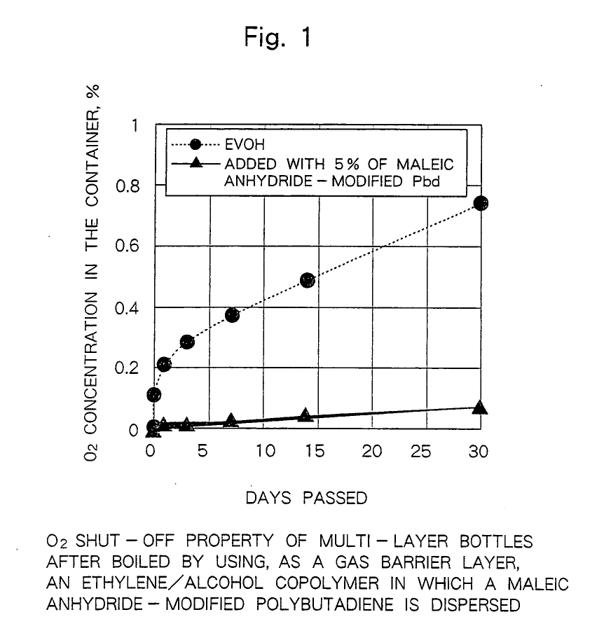

FIG. 1 in the attached drawing is a graph plotting a relationship between the days that have passed and an increase (%) in the amount of oxygen in the container when a bottle having a multi-layer structure of propylene/gas barrier layer (20 to 25 μm thick)/polypropylene is boiled and is, then, aged at 30° C. (100% RH inside the bottle and 80% RH outside the bottle).

The above result tells that in the bottle using the ethylene/vinyl alcohol copolymer as the gas barrier layer, the oxygen concentration sharply increases right after the boiling and, further, continues to increase with the passage of time. In the bottle forming the fine dispersion structure and the multi-layer profile structure by blending the ethylene/vinyl alcohol copolymer with a transition metal catalyst and an oxidizing organic component, on the other hand, an increase in the oxygen concentration right after the boiling is suppressed and a subsequent increase in the oxygen concentration with the passage of time is suppressed, too, manifesting unexpected action and effect of the present invention.

In the dispersion structure in which the gas barrier thermoplastic resin is existing as a continues phase (matrix) and the oxidizing organic component is existing as a dispersion phase, in particular, the surface areas of the oxidizing organic component which is the dispersion phase is increasing, whereby oxygen is efficiently absorbed. Even after the oxidation of the dispersion layer has proceeded, the gas barrier thermoplastic resin remains as a continuous phase offering an advantage of maintaining excellent gas shut-off property and mechanical strength. Further, since the oxidizing organic component is covered with the continuous phase of gas barrier thermoplastic resin, there is obtained such an advantage of excellent hygienic property.

The dispersion and profile structures of the oxidizing organic component in the gas barrier layer can be quantitatively treated by finding an average particle diameter of dispersed particles by the area method in cross section of the gas barrier method in the direction of thickness and by finding the area ratio occupied by the dispersed particles in cross section of the gas barrier layer in the direction of thickness.

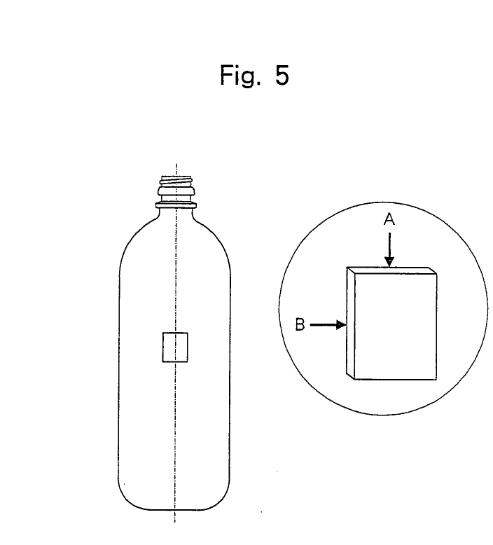

Referring to FIG. 5, the cross section of the gas barrier layer in the direction of thickness according to the present invention may be either a cross section (direction of arrow A) in a direction perpendicular to the direction of height thereof or a cross section (direction of arrow B) in a direction in parallel therewith provided the multi-layer structure is a barrel portion of a container of the shape of bottle.

When the multi-layer structure is a sheet or a film, the cross section may be either the one in a direction perpendicular to the direction of winding or the one in parallel therewith.

When the gas barrier layer is stretched, the diameters of the dispersed particles and the area occupied by the dispersed particle differ depending upon a direction in parallel with the direction of stretch or a direction perpendicular thereto. According to the present invention, however, excellent barrier property and mechanical strength are maintained if the average diameter of the dispersed particles of the oxidizing polymer is not larger than 1 μm in either one cross section which is in parallel with the direction of stretch or is perpendicular thereto and if the area ratio occupied by the dispersed particles is not smaller than 1% in cross section of the gas barrier layer in the direction of thickness.

The oxidizing organic component contained as a dispersion phase in the gas barrier layer can be dyed by using a dye capable of selectively dying the oxidizing organic component only in cross section of the gas barrier layer.

The cross section of the gas barrier layer after dyed is photographed by using a scanning-type electron microscope (SEM), the picture of the SEM photograph is read by a scanner, the oxidizing organic component and other portions are discriminated from one another on a PC screen by using a picture processing software, thereby to measure the number n of dispersed particles and the area S of the dispersed oxidizing organic component particles present on a predetermined area Sₒ. This operation is conducted for a plurality of visual fields to enhance the precision, ΣS and Σn are calculated from S and n found from the visual fields, and an area average particle diameter d is found from the following formula (1),
d=(ΣS/Σn)^{1/2} (1)

Further, in compliance with the following formula (2), an area ratio α occupied by the dispersed particles is found from the above Sₒ and S that have been found for the plurality of visual fields,
α=100×ΣS/ΣSₒ (2)

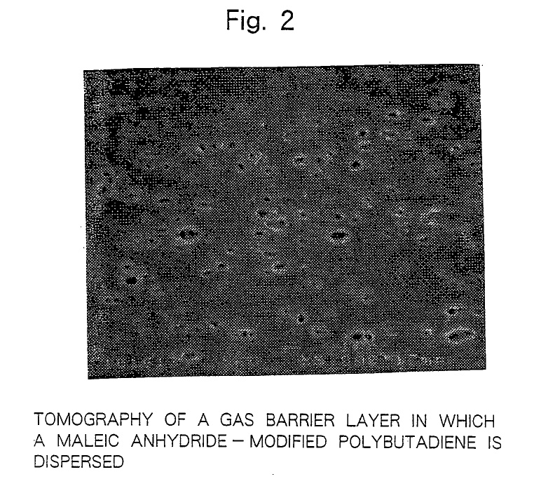

FIG. 2 in the accompanying drawing is a scanning-type electron microphotograph of a gas barrier layer having dispersion and profile structures in cross section in the direction of thickness according to the present invention, the continuous phase being an ethylene/vinyl alcohol copolymer and the dispersion phase being a maleic anhydride-modified polybutadiene.

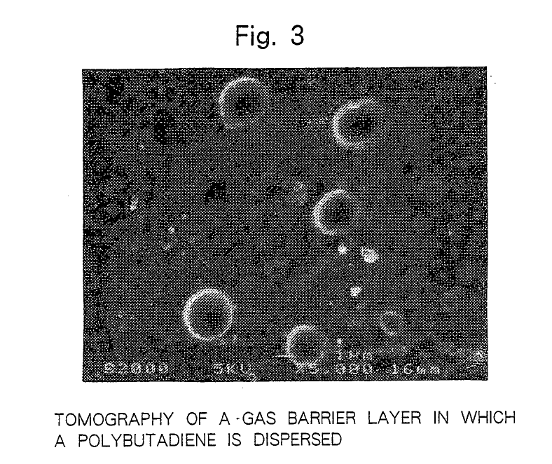

FIG. 3 is a scanning-type electron microphotograph of another gas barrier layer having dispersion and profile structures in cross section in the direction of thickness falling outside the scope of the present invention, the continuous phase being an ethylene/vinyl alcohol copolymer and the dispersion phase being a polybutadiene.

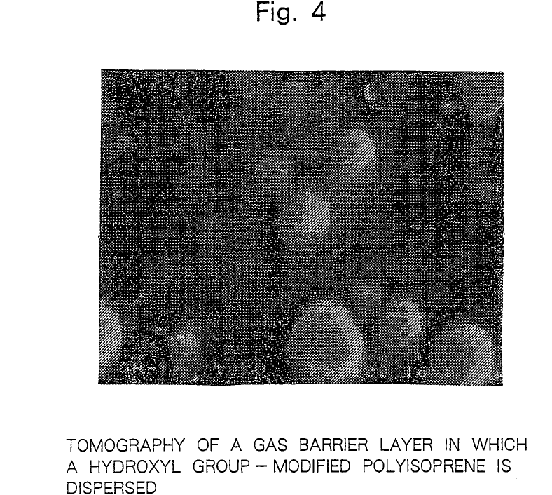

FIG. 4 is a scanning-type electron microphotograph of a further gas barrier layer having dispersion and profile structures in cross section in the direction of thickness falling outside the scope of the present invention, the continuous phase being an ethylene/vinyl alcohol copolymer and the dispersion phase being an OH-modified polyisoprene.

Referring to these scanning-type electron microphotograph, an unexpected fact becomes obvious in that the present invention is accomplishing dispersed particles of exceptionally fine sizes.

In the present invention, the average diameter of dispersed particles of the oxidizing organic component as found by an area method is selected to be not larger than 1 μm in cross section of the gas barrier layer in the direction of thickness thereof, and an area ratio occupied by the dispersed particles is selected to be not smaller than 1% in cross section of the gas barrier layer in the direction of thickness thereof, making it possible to suppress the oxygen permeation amount to a small value under high-temperature and wet conditions.

A multi-layer structure having the above dispersion and profile structures can be favorably molded, enables the molded structure to possess homogeneous texture and homogeneous appearance, featuring uniform thickness and excellent smoothness.

Further, since the oxidizing organic component is present in the dispersion structure, the crystallinity of the gas barrier resin itself and the intermolecular cohesive force are adversely affected little as compared to when the oxidizing organic component is existing in the form of molecules. Even after the oxidizing organic component has lost the activity, the gas barrier resin itself maintains barrier property.

Any known method can be used for controlling the dispersion structure, such as a method of finely dispersing the oxidizing organic component by using a compatibility-imparting agent, or a method which imparts a particular functional group to the oxidizing organic material itself so that the oxidizing organic component is finely dispersed. In effect, the oxidizing organic component is controlled to possess the dispersion structure to exhibit excellent gas barrier property.

In the multi-layer structure of the present invention, when the direction of thickness of the gas barrier layer is regarded to be a short axis and a direction perpendicular to the direction of thickness is regarded to be a long axis in cross section of the gas barrier layer in the direction of thickness thereof, a maximum value of an aspect ratio of dispersed particles of the oxidizing organic component represented by the length in the long axis direction/length in the short axis direction, is selected to be not smaller than 2, in order to suppress the amount of oxygen permeation down to a lower level under high-temperature and wet conditions.

To measure the aspect ratio, the above-mentioned SEM photograph is enlarged, lines are drawn in the direction of thickness (short axis direction) of the gas barrier layer and in the direction (long axis direction) perpendicular thereto, the lengths of the dispersed particles are found in the long axis direction and in the short axis direction, the aspect ratio (length in the long axis direction/length in the short axis direction) is found, and a maximum aspect ratio of the dispersed particles is found.

It is desired that the oxidizing organic component used in the present invention contains a resin modified with a carboxylic acid or a carboxylic anhydride. The oxidizing organic component modified with the carboxylic acid or carboxylic anhydride can be finely and homogeneously dispersed in the gas barrier resin suppressing the amount of oxygen permeation down to a low value and improving the thickness and surface homogeneity of the multi-layer structure.

The acid value of the oxidizing organic component for obtaining good dispersion property tends to vary depending upon the number average molecular weight of the oxidizing organic component. As the number average molecular weight increases, there is obtained good dispersion with a small acid value. A preferred acid value may be adjusted depending upon the number average molecular weight and is, desirably, not smaller than 5 KOHmg/g.

[Gas Barrier Thermoplastic Resin]

The present invention uses a thermoplastic resin having an oxygen permeation coefficient at 20° C. and 0% RH of not larger than 10⁻¹² cc·cm/cm²/sec/cmHg as a base resin of the gas barrier layer.

Any thermoplastic resin can be used so far as it satisfies the above-mentioned conditions. Particularly preferred examples include ethylene/vinyl alcohol copolymer, polyamide or copolymer thereof, barrier polyester, and combinations thereof.

In the present invention, it is desired to use an ethylene/vinyl alcohol copolymer as a resin having particularly excellent barrier property against oxygen and flavor component. The ethylene/vinyl alcohol copolymer may be any known one such as a saponified copolymer obtained by saponifying an ethylene/vinyl acetate copolymer containing ethylene in an amount of from 20 to 60 mol % and, particularly, from 25 to 50 mol % such that the degree of saponification is not smaller than 96 mol % and, particularly, not smaller than 99 mol %.

The saponified ethylene/vinyl alcohol copolymer should have a molecular weight large enough for forming a film, and desirably has a viscosity of, generally, not smaller than 0.01 dL/g and, particularly, not smaller than 0.05 dL/g in a mixed solvent of phenol and water at a weigh ratio of 85 to 15 at 30° C.

As the polyamide resin, there can be exemplified (a) an aliphatic, alicyclic or semi-aromatic polyamide derived from a dicarboxylic acid component and a diamine component, (b) a polyamide derived from an aminocarboxylic acid or a lactam thereof, or a copolyamide thereof or a blend thereof.

As the dicarboxylic acid component, there can be exemplified aliphatic dicarboxylic acids having 4 to 15 carbon atoms, such as succinic acid, adipic acid, sebacic acid, decanedicarboxylic acid, undecanedicarboxylic acid and dodecanedicarboxyic acid; and aromatic dicarboxylic acids such as terephthalic acid and isophthalic acid.

As the diamine component, there can be exemplified straight chain or branched chain alkylene diamines having 4 to 25 and, particularly, 6 to 18 carbon atoms, such as 1,6-diaminohexane, 1,8-diaminooctane, 1,10-diaminodecane, and 1,12-diaminododecane; alicyclic diamines such as bis(aminomethyl)cyclohexane, bis(4-aminocyclohexyl)methane, 4,4′-diamino-3,3′-dimethyldicyclohexylmethane and, particularly, bis(4-aminocyclohexyl)methane, 1,3-bis(aminocyclohexyl)methane, and 1,3-bis(aminomethyl)cyclohexane; and aroaliphatic diamines such as m-xylylenediamine and/or p-xylylenediamine.

As the aminocarboxylic acid component, there can be exemplified aliphatic aminocarboxylic acids such as ω-aminocaproic acid, ω-aminooctanoic acid, ω-aminoundecanoic acid, ω-aminododecanoic acid; and aroalicyclic aminocarboxylic acids such as para-aminomethylbenzoic acid and para-aminophenylacetic acid.

Among these polymides, it is desired to use a polyamide containing a xylylene group. Concrete examples include homopolymers such as polymetaxylylene adipamide, polymetaxylylene sebacamide, polymetaxylylene suberamide, polyparaxylylene pimelamide, and polymetaxylylene azeramide; copolymers such as metaxylene/paraxylylene adipamide copolymer, metaxylylene/paraxylylene pimeramide copolymer, metaxylylene/paraxylylene sebacamide copolymer and metaxylylene/paraxylylene azeramide copolymer; copolymers obtained by copolymerizing the components of these homopolymers or copolymers with aliphatic diamine such as hexamethylenediamine, alicyclic diamine such as piperazine, aromatic diamine such as para-bis(2-aminoethyl)benzene, aromatic dicarboxylic acid such as terephthalic acid, lactam such as ε-caprolactam, ω-aminocarboxylic acid such as 7-aminoheptanoic acid, or with aromatic aminocarboxylic acid such as para-aminomethylbenzoic acid. However, there can be particularly preferably used a polyamide obtained from a diamine component comprising, chiefly, m-xylylenediamine and/or p-xylylenediamine and from aliphatic dicarboxylic acid and/or aromatic dicarboxylic acid.

These xylylene group-containing polyamides exhibit superior oxygen barrier property to other polyamide resins, and are suited for accomplishing the object of the present invention.

In the present invention, it is desired that the polyamide resin has terminal amino groups at a concentration of not smaller than 40 eq/10⁶ g and, more preferably, not smaller than 50 eq/10⁶ g from the standpoint of suppressing the degradation of the polyamide resin due to oxidation.

There is an intimate relationship between the degradation of the polyamide resin due to oxidation, i.e., absorption of oxygen and the concentration of terminal amino groups of the polyamide resin. That is, when the concentration of terminal amino groups of the polyamide resin lies within the above-mentioned relatively high range, the rate of oxygen absorption is suppressed to be almost zero or to a value close to zero. When the concentration of terminal amino groups of the polyamide resin becomes smaller than the above range, on the other hand, the rate of absorbing oxygen of the polyamide resin tends to increase.

These polyamides should have molecular weights large enough for forming a film, and, desirably, have a relative viscosity (ηrel) of not smaller than 1.1 and, particularly, not smaller than 1.5 as measured in the concentrated sulfuric acid at a concentration of 1.0 g/dl and at a temperature of 30° C.

As the thermoplastic resin, there can be used an aromatic dicarboxylic acid such as terephthalic acid or isophthalic acid, and a thermoplastic polyester derived from diols such as ethylene glycol.

As the thermoplastic resin having excellent gas barrier property, there can be used a so-called gas barrier polyester. The gas barrier polyester contains, in a polymer chain thereof, a terephthalic acid component (T) and an isophthalic acid component (I) at a molar ratio of T:I=95:5 to 5:95 and, particularly, T:I=75:25 to 25:75, and contains an ethylene glycol component (E) and a bis(2-hydroxyethoxy)benzene component (BHEB) at a molar ratio of E:BHEB=99.999:0.001 to 2.0:98.0 and, particularly, E:BHEB=99.95:0.05 to 40:60. As the BHEB, there is preferably used a 1,3-bis(2-hydroxyethoxy)benzene.

The polyester should have a molecular weight at least large enough for forming a film and, desirably, has an inherent viscosity [η] of, generally, from 0.3 to 2.8 dl/g and, particularly, from 0.4 to 1.8 dl/g as measured in a mixed solvent of phenol and tetrachloroethane at a weight ratio of 60:40 at a temperature of 30° C.

It is also allowable to use a polyester resin comprising, chiefly, a polyglycol acid, or a polyester resin obtained by blending the above polyester resin with a polyester resin derived from the aromatic dicarboxylic acid and diols.

[Oxidizing Organic Component]

In the present invention, the gas barrier resin is blended with a transition metal catalyst and an oxidizing organic component.

It is desired that the oxidizing organic component has active carbon atoms so as to easily pull out hydrogen. Though there is no particular limitation, the active carbon atoms may be those carbon atoms neighboring the carbon-carbon double bond, tertiary carbon atoms coupled to a chain on the carbon side or an active methylene group.

As the oxidizing organic component, it is desired to use a polyene-type polymer. As the polyene used for the polyene-type polymer, there can be used a polyene having 4 to 20 carbon atoms, an oligomer or a polymer containing a unit derived from a chained or cyclic conjugated or non-conjugated polyene.

As the monomers, there can be exemplified conjugated dienes such as butadiene and isoprene; chained non-conjugated dienes such as 1,4-hexadiene, 3-methyl-1,4-hexadiene, 4-methyl-1,4-hexadiene, 5-methyl-1,4-hexadiene, 4,5-dimethyl-1,4-hexadiene and 7-methyl-1,6-octadiene; cyclic non-conjugated dienes such as methyltetrahydroindene, 5-ethylidene-2-norbornene, 5-methylene-2-norbornene, 5-isopropylidene-2-norbornene, 5-vinylidene-2-norbornene, 6-chloromethyl-5-isopropenyl-2-norbornene and dicyclopentadiene; and triene and chloroprene such as 2,3-diisopropylidene-5-norbornene, 2-ethylidene-3-isopropylidene-5-norbornene, 2-propenyl-2 and 2-norbornadiene.

These polyenes can be used in a single kind or in a combination of two or more kinds, or can be used in the form of a homopolymer, random copolymer or a block copolymer in combination with other monomers.

As the monomer used in combination with the polyene, there can be exemplified α-olefins having 2 to 20 carbon atoms, such as ethylene, propylene, 1-butene, 4-methyl-1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-nonadecene, 1-eicosene, 9-methyl-1-decene, 11-methyl-1-dodecene, and 12-ethyl-1-tetradecene. There can be further used such monomers as styrene, vinyltoluene, acrylonitrile, methacrylonitrile, vinyl acetate, methyl methacrylate and ethyl acrylate.

Concrete examples of the polyene-type polymer include polybutadiene (BR), polyisoprene (IR), butyl rubber (IIR), natural rubber, nitrile-butadiene rubber (NBR), styrene-butadiene rubber (SBR), styrene-isoprene rubber (SIR), chloroprene rubber (CR) and ethylene-propylene-diene rubber (EPDM) to which only, however, the polyene-type polymer is in no way limited.

The carbon-carbon double bond in the polymer may be present on the main chain in the form of a vinylene group or may be present on the side chain in the form of a vinyl group without any particular limitation. In effect, the carbon-carbon double bond may be the one capable of being oxidized. The one in the form of the vinyl group is desirable from the standpoint of high rate of oxidation.

It is desired that the oxidizing organic component used in the present invention has a functional group. As the functional group, there can be exemplified carboxylic acid group, carboxylic anhydride group, carboxylic acid ester group, carboxylic acid amide group, epoxy group, hydroxyl group, amino group and carbonyl group. Among them, carboxylic acid group and carboxylic anhydride group are particularly desired from the standpoint of compatibility. These functional groups may be present on the side chains or at the terminals of the resin.

When the oxidizing organic component is a polyene-type polymer, an ethylenically unsaturated monomer having the above functional group is used as a monomer for introducing the functional groups.

As the monomer used for introducing the carboxylic acid group or carboxylic anhydride group into the polyene-type polymer, there is desirably used an unsaturated carboxylic acid or a derivative thereof. Concretely, there can be exemplified α,β-unsaturated carboxylic acids such as acrylic acid, methacrylic acid, maleic acid, fumaric acid, itaconic acid, citraconic acid and tetrahydrophthalic acid; unsaturated carboxylic acids such as bicyclo[2,2,1]hepto-2-ene-5,6-dicarboxylic acid; α,β-unsaturated carboxylic anhydrides such as maleic anhydride, itaconic anhydride, citraconic anhydride and tetrahydrophthalic anhydride; and anhydrides of unsaturated carboxylic acid, such as bicyclo[2,21]hepto-2-ene-5,6-dicarboxylic anhydride.

The polyene-type polymer modified with acid is prepared by graft-copolymerizing the polyene-type polymer which is a base polymer with an unsaturated carboxylic acid or a derivative thereof by known means. The polyene-type polymer modified with acid, however, can further be prepared by random-copolymerizing the polyene-type polymer with an unsaturated carboxylic acid or a derivative thereof.

The oxidizing organic component having the carboxylic acid or the carboxylic anhydride group disperses well in the ethylene/vinyl alcohol copolymer, and smoothly absorbs oxygen.

The oxidizing organic component used in the present invention is the one obtained by modifying the polyene-type polymer with the carboxylic acid or the carboxylic anhydride. The oxidizing organic component in the state of a liquid resin being modified with acid or acid anhydride is desirable from the standpoint of dispersion in the gas barrier resin.

It is desired that the oxidizing organic component used in the present invention is capable of absorbing oxygen in an amount of not smaller than 2×10⁻³ mol and, particularly, not smaller than 4×10⁻³ mol per gram of the oxidizing organic component at normal temperature in the presence of a transition metal catalyst. When the oxygen absorbing ability is smaller than the above value, the gas barrier resin must be blended with the oxidizing organic component in large amounts to develop good oxygen barrier property. As a result, the resin composition after blended exhibits deteriorated workability and formability.

[Transition Metal Catalyst]

Preferred examples of the transition metal catalyst used in the present invention include metal components of the Group VIII of periodic table, such as iron, cobalt, nickel and the like. There can be further exemplified metals of the Group I, such as copper, silver and the like; metals of the Group IV, such as tin, titanium, zirconium and the like; metals of the Group V, such as vanadium; metals of the Group VI, such as chromium; and metals of the Group VIII, such as manganese. Among these metal components, cobalt exhibits a large oxygen absorbing rate and is particularly suited for the object of the present invention.

The transition metal catalyst is usually used in the form of an inorganic salt, an organic salt or a complex of the above transition metal having a low valency.

As the inorganic salt, there can be exemplified halide such as chloride, oxyacid salt of sulfur such as sulfate, oxyacid salt of nitrogen such as nitrate, phosphorus oxyacid salt such as phosphate, and silicate.

As the organic salt, on the other hand, there can be exemplified carboxylate, sulfonate, and phosphonate. Among them, carboxylate is suited for the object of the present invention. Its concrete examples include transition metal salts of acetic acid, propionic acid, isopropionic acid, butanoic acid, isobutanoic acid, pentanoic acid, isopentanoic acid, hexanoic acid, heptanoic acid, isoheptanoic acid, octanoic acid, 2-ethylhexanoic acid, nonanoic acid, 3,5,5-trimethylhexanoic acid, decanoic aid, neodecanoic acid, undecanoic acid, lauric acid, myristic acid, palmitic acid, margaric acid, stearic acid, arachic acid, linderic acid, tsuzuic acid, petroselinic acid, oleic acid, linoleic acid, linolenic acid, arachidonic acid, formic acid, oxalic acid, sulfamic acid and naphthanic acid.

As the complex of a transition metal, there is used a complex with β-diketone or β-keto-acid ester. As the β-diketone or β-keto-acid ester, there can be used, for example, acetylacetone, ethyl acetoacetate, 1,3-cyclohexadion, methylenebis-1,3-cyclohexadion, 2-benzyl-1,3-cyclohexadion, acetyltetralone, palmitoyltetralone, stearoyltetralone, benzoyltetralone, 2-acetylcyclohexanone, 2-benzoylcyclohexanone, 2-acetyl-1,3-cyclohexanedion, benzoyl-p-chlorobenzoylmethane, bis(4-methylbenzoyl)methane, bis(2-hydroxybenzoyl)methane, benzoylacetone, tribenzoylmethane, diacetylbenzoylmethane, stearoylbenzoylmethane, palmitoylbenzoylmethane, lauroylbenzoylmethane, dibenzoylmethane, bis(4-chlorobenzoyl)methane, bis(methylene-3,4-dioxybenzoyl)methane, benzoylacetylphenylmethane, stearoyl(4-methoxybenzoyl)methane, butanoylacetone, distearoylmethane, acetylacetone, stearoylacetone, bis(cyclohexnoyl)methane and dipivaroylmethane.

[Resin Composition]

In the present invention, it is desired that the ethylene/vinyl alcohol copolymer or the like is blended with the oxidizing organic component in such an amount that the area ratio occupied by the dispersed particles is not smaller than 1% and, particularly, not smaller than 2% in cross section of the gas barrier layer in the direction of thickness. There is no particular limitation on the area ratio provided the gas barrier layer has a structure in which the gas barrier resin is forming a continuous layer and the oxidizing organic component is forming a dispersion layer. From the standpoint of stability of the dispersion structure, however, it is desired that the upper limit of the area ratio is not larger than 30% and, particularly, not larger than 20%.

In this case, further, it is desired that the amount of blending the oxidizing organic component in the resin composition is not larger than 30% by weight and, particularly, not larger than 20% by weight from the standpoint of workability and formability of the resin composition.

In this resin composition, further, it is desired that the transition metal catalyst is contained in an amount of from 100 to 1000 ppm and, particularly, from 200 to 500 ppm calculated as a transition metal amount per the total amount of the gas barrier resin and the oxidizing organic component.

When the area ratio of the oxidizing organic component is smaller than the above-mentioned range, the oxygen barrier property becomes insufficient as compared to when the area ratio is within the above range.

When the amount of the transition metal catalyst is smaller than the above-mentioned range, further, the gas barrier property tends to decrease as compared to when the amount lies within the above range. When this amount exceeds the above range, the resin composition tends to be deteriorated when it is formed by being kneaded, which is not desirable.

The ethylene/vinyl alcohol copolymer can be blended with the transition metal catalyst and with the oxidizing organic component by a variety of means. There is no particular order for the blending; i.e., the blending can be effected in any order.

In order to homogeneously blend the above components and to prevent undesired oxidation of before the use as much as possible, however, it is generally desired that the transition metal catalyst is dissolved in an organic solvent, the solvent is mixed with a base resin such as a powdery or granular ethylene/vinyl alcohol copolymer and, as required, the mixture is dried in an inert atmosphere, since the amount of the transition metal catalyst is smaller than that of the base resin such as the ethylene/vinyl alcohol copolymer.

It is, on the other hand, desired that the base resin such as the ethylene/vinyl alcohol copolymer carrying the above transition metal catalyst is melt-blended with the oxidizing organic component. This helps prevent a side reaction or a pre-reaction of the transition metal catalyst with the oxidizing organic component.

As the solvent for dissolving the transition metal catalyst, there can be used alcohol solvents such as methanol, ethanol and butanol; ether solvents such as dimethyl ether, diethyl ether, methyl ethyl ether, tetrahydrofuran and dioxane; ketone solvents such as methyl ethyl ketone and cyclohexanone; and hydrocarbon solvents such as n-hexane and cyclohexane. Usually, the solvent is used in such an amount that the concentration of the transition metal catalyst is from 5 to 90% by weight.

It is desired that the ethylene/vinyl alcohol copolymer which is the base resin, oxidizing organic component and the transition metal catalyst are mixed and are, then, preserved in a non-oxidizing atmosphere so will not to be oxidized during the stage preceding the composition. For this purpose, it is desired that the mixing and drying are conducted under a reduced pressure condition or in a nitrogen stream.

The mixing and/or the drying can be conducted in a stage preceding the step of formation by using a vent-type or dryer-equipped extruder or injector.

In the most preferred embodiment of the invention, the base resin such as the ethylene/vinyl alcohol copolymer smeared with the transition metal catalyst is melted and kneaded in advance by using a biaxial extruder having a side feed, and the oxidizing organic component is fed into the melt-kneaded mixture so as to homogeneously knead them together.

The kneading system using the biaxial extruder is capable of effecting the kneading at a low temperature and under a low pressure, making it possible to obtain a homogeneously kneaded product while preventing the occurrence of gel or the like.

The gas barrier layer used in the present invention can, as desired, be blended with a known activating agent though it is not usually needed. Though not limited thereto only, suitable examples of the activating agent include polyethylene glycol, polypropylene glycol, ethylene/methacrylic acid copolymer, and polymers containing hydroxyl groups such as various ionomers and/or carboxyl groups.

The hydroxyl group-containing and/or carboxyl group-containing polymers can be blended in an amount of not larger than 30 parts by weight and, particularly, from 0.01 to 10 parts by weight per 100 parts by weight of the ethylene/vinyl alcohol copolymer.

The oxygen-absorbing layer used in the present invention can be blended with known blending agents, such as filler, coloring agent, heat-resisting stabilizer, anti-aging stabilizer, anti-oxidant, anti-aging agent, photo stabilizer, ultraviolet ray absorber, antistatic agent, metal soap, lubricant such as wax, reforming resin and rubber according to known recipe.

Upon blending the lubricant, for example, the resin is more favorably picked up by the screw. The lubricant may be a metal soap such as magnesium stearate or calcium stearate; the one of the hydrocarbon type, such as fluidized, natural or synthetic paraffin, microwax, polyethylene wax or chlorinated polyethylene wax; the one of the fatty acid type, such as stearic acid or lauric acid; the one of the type of fatty acid monoamide or bisamide, such as stearic acid amide, palmitic acid amide, oleic acid amide, erucic acid amide, methylenebisstearo amide, or ethylenebisstearo amide; the one of the ester type, such as butyl stearate, cured castor oil or ethylene glycol monostearate; or a mixed system thereof. A suitable amount of addition of the lubricant is from 50 to 1000 ppm based on the thermoplastic resin.

After melt-blended, the resin composition of the present invention is such that the ethylene/vinyl alcohol copolymer which is the base resin is forming a continuous phase (matrix) and the oxidizing organic component is forming a dispersion phase.

[Multi-Layer Structure]

In the present invention, at least one layer of the gas barrier member is combined, as required, with at least one layer of other resin to obtain a plastic multi-layer structure such as cup, tray, bottle, tubular container or pouch.

In general, it is desired that the gas barrier layer is formed on the inside of the container rather than on the outer surface so will not to be exposed to the outer surface. It is further desired that the gas barrier layer is formed on the outer side of the inner surface of the container so will not to come into direct touch with the content. It is thus desired to provide the gas barrier layer as at least one intermediate layer of the multi-layer resin container.

In the case of a container of the multi-layer constitution, the other resin layer to be used in combination with the gas barrier layer may be a moisture-resistant resin such as olefin resin or thermoplastic polyester resin, or any other gas barrier resin.

As the olefin resin, there can be exemplified polyethylenes (PE) such as low density polyethylene (LDPE), middle density polyethylene (MDPE), high density polyethylene (HDPE), linear low density polyethylene (LLDPE) and linear very low density polyethylene (LVLDPE), as well as polypropylene (PP), ethylene/propylene copolymer, polybutene-1, ethylene/butene-1 copolymer, propylene/butene-1 copolymer, ethylene/propylene/butene-1 copolymer, ethylene/vinyl acetate copolymer and tonically crosslinked olefin copolymer (ionomer) or a blend thereof.

As the thermoplastic polyester resin, there can be exemplified a polyester resin comprising chiefly polyethylene terephthalate (PET), polybutylene terephthalate (PBT), polyethylene naphthalate (PEN), polyester resin comprising chiefly a polyglycolic acid, or a copolymerized polyester thereof, or a blend thereof.

As other examples of the barrier resin, there can be used cyclic olefin-type copolymer (COC) and, particularly, a copolymer of ethylene and cyclic olefin and, more particularly, APEL of Mitsui Chemical Co.

Described below are suitable examples of the container laminated-layer structure where OBR stands for a layer of the oxygen barrier resin composition (hereinafter simply referred to as oxygen barrier layer). Which layer be formed on the inner surface side is freely selected depending upon the object.
Two-layer structure: PET/OBR, PE/OBR, PP/OBR.
Three-layer structure: PE/OBR/PET, PET/OBR/PET, PE/OBR/PP, EVOH/OBR/PET, PE/OBR/COC.
Four-layer structure: PE/PET/OBR/PET, PE/OBR/EVOH/PET, PET/OBR/EVOH/PET, PE/OBR/EVOH/COC.
Five-layer structure: PET/OBR/PET/OBR/PET, PE/PET/OBR/EVOH/PET, PET/OBR/EVOH/COC/PET PET/OBR/PET/COC/PET, PE/OBR/EVOH/COC/PET.
Six-layer structure: PET/OBR/PET/OBR/EVOH/PET, PE/PET/OBR/COC/EVOH/PET, PET/OBR/EVOH/PET/COC/PET
Seven-layer structure: PET/OBR/COC/PET/EVOH/OBR/PET.

In producing the above laminates, an adhesive resin may, as required, be interposed among the resin layers.

As the adhesive resin, there can be exemplified a thermoplastic resin containing carbonyl (—CO—) groups based upon carboxylic acid, carboxylic anhydride, carboxylate, carboxylic acid amide or carboxylic acid ester at a concentration of 1 to 700 milliequivalent (meq)/100 g of resin and, particularly, at a concentration of 10 to 500 meq/100 g of the resin on the main chain or on the side chains. Preferred examples of the adhesive resin include ethylene/acrylic acid copolymer, ionically crosslinked olefin copolymer, maleic anhydride-grafted polyethylene, maleic anhydride-grafted polypropylene, acrylic acid-grafted polyolefin, ethylene/vinyl acetate copolymer, copolymerized polyester and copolymerized thermoplastic resin, which may be used in one kind or in a combination of two or more kinds. These resins can be effectively laminated by the simultaneous extrusion or by the sandwich lamination.

Further, a thermosetting adhesive resin of the isocyanate type or the epoxy type can be used as the adhesive layer for adhering the gas barrier resin film that has been formed in advance to the moisture-resistant resin film.

In the multi-layer structure of the present invention, though there is no particular limitation, it is desired that the thickness of the gas barrier layer generally lies in a range of from 3 to 100 μm and, particularly, from 5 to 50 μm. That is, when the thickness of the gas barrier layer becomes smaller than a given range, the gas barrier performance becomes poor. Even when the thickness becomes larger than the given range, on the other hand, there is obtained no particularly distinguished advantage in regard to the gas barrier property but rather disadvantage results concerning the economy such as an increase in the amount of resin and a decrease in the flexibility and softness of the material.

In the multi-layer structure of the present invention, it is desired that the entire thickness is generally from 30 to 7000 μm and, particularly, from 50 to 5000 μm though it may vary depending upon the use. It is, on the other hand, desired that the oxygen barrier intermediate layer has a thickness which is from 0.5 to 95% and, particularly, from 1 to 50% of the entire thickness.

The multi-layer structure of the present invention can be produced by a known method with the exception of using the gas barrier layer.

For example, the film, sheet or tube is formed by melt-kneading the above resin composition by using an extruder and extruding it into a predetermined shape through a T-die or a circular die (ring die) thereby to obtain a T-die film, an inflation film or the like film. The T-die film is biaxially stretched to obtain a biaxially stretched film.

Further, the resin composition is melt-kneaded by using an injector, and is injected into an injection metal mold thereby to produce a container or a preform for producing a container.

Further, the resin composition is extruded into a mass of a molten resin through the extruder and is compression-molded by using a metal mold to produce a container or a preform for producing a container.

The molded article may assume the shape of a film, a sheet, a parison or a pipe for forming a bottle or a tube, and a preform for forming a bottle or a tube.

The bottle is easily formed from the parison, pipe or preform by pinching-off the extruded article by using a pair of split molds, and by blowing a fluid therein.

After cooled, further, the pipe or the preform is heated at a drawing temperature and is stretched in the axial direction and is further blow-stretched in the circumferential direction by utilizing the fluid pressure to obtain a draw-blown bottle or the like.

Further, the film or sheet is subjected to such means as vacuum molding, compressed air molding, inflation molding or plug assisted molding to obtain a packaging container in the shape of a cup or tray and a cover member formed of a film or a sheet.

The packaging material such as a film can be used as packaging bags of a variety of forms, and can be produced by a known bag-producing method. Examples of the bag include ordinary three-side sealed or four-side sealed pouches, pouches with gusset, standing pouches and pillow-wrapping bags, to which only, however, the bags are in no way limited.

The multi-layer extrusion molded article can be produced by using a known co-extrusion molding method by using extruders of a number corresponding to the kinds of the resins, and by conducting the extrusion molding in the same manner as described above but using a multi-layer multiple die.

Further, the multi-layer injection molded article is produced relying upon the co-injection method or the sequential injection method by using the injection molding machines of a number corresponding to the kind of the resins.

Further, the multi-layer film and the multi-layer sheet are produced relying upon the extrusion coating method or the sandwich lamination method. Further, the multi-layer film or sheet can be produced by dry-laminating the films that have been formed in advance.

The multi-layer container of the present invention is useful for preventing a drop of flavor of the content caused by oxygen.

The contents that can be contained may be such beverages as beer, wine, fruit juices, carbonated soft drinks, etc., such foods as fruits, nuts, vegetables, meet products, infant's foods, coffee, jam, mayonnaise, ketchup, edible oil, dressing, sauces, food boiled down in soy, milk products, etc., as well as medicines, cosmetics, gasoline, etc. that are subject to be deteriorated in the presence of oxygen, though the contents are in no way limited thereto only.

### EXAMPLES

The present invention will now be described by way of Examples to which only, however, the invention is not limited.

[Measurement of Diameter of Dispersed Particles, Aspect Ratio of the Dispersed Particles and Area Ratio Occupied by the Dispersed Particles]

A multi-layer structure cut from a multi-layer bottle, multi-layer cup or laminated film was buried in an epoxy/amine-type burying film for electron microscope, and the burying resin was cured. Then, the burying sample was polished by using a microtome (2050 SUPERCUT: Leica Co.) such that there appeared the cross section in the direction of thickness of the multi-layer structure (cross section in a direction perpendicular to the direction of height when the multi-layer structure was a barrel of a container of the shape of a bottle or a cup, or cross section in a direction perpendicular to the drawing direction when the multi-layer structure was a sheet or a film). Then, the burying sample was immersed in osmic acid a whole day to dye carbon-carbon double bond moiety of the polyene polymer. The burying sample after dyed was finish-polished by using an ultra-microtome (REIHERT URLTRACUTS: Leica Co.), and was observed by using a scanning-type electron microscope (JSM-6300F: Nihon Denshi Co.) at a magnification of 3,000 to 20,000 times to take an SEM photograph.

The picture of the SEM photograph was taken in by a scanner (GT-7600U: Seiko-Epson Co.). The polyene polymer moiety was distinguished from other portions on a PC screen by using a picture processing software to thereby measure an area S of dispersed particles of the polyene polymer present on a predetermined area Sₒ and the number n of dispersed particles. The operation was conducted for a plurality of visual fields to improve the precision, ΣS and Σn were calculated from S and n found from the visual fields, and an area average particle diameter d was found in compliance with the following formula (1),
d=(ΣS/Σn)^{1/2} (1)

From Sₒ and S found from the plurality of visual fields, further, an area ratio α occupied by the dispersed particles was found in compliance with the following formula,
α=100×ΣS/ΣSₒ (2)

Further, the above SEM photograph was enlarged, lines were drawn in a direction of thickness (short axis direction) of the gas barrier layer and in a direction (long axis direction) perpendicular thereto to find a length of the dispersed particles in the long axis direction and a length thereof in the short axis direction, to find an aspect ratio (length in the long axis direction/length in the short axis direction), and to obtain a maximum aspect ratio of the dispersed particles.

[Measurement of Acid Value]

The sample was completely dissolved in a suitable solvent and was, then, titrated with an alcoholic 0.1N KOH solution to find the total acid value of the sample.

[Measurement of the Number Average Molecular Weight]

The sample was dissolved in chloroform and was measured for its number average molecular weight by using a gel permeation chromatography (column: TSK G5000HHR+4000HHR: Toso Co.) to which was connected a detection system (TriSEC 302TDA detector: Asahi Techneion Co.) equipped with a light scattering detector, a refraction detector and a viscosity detector.

[Measurement of Oxygen Permeation Property of Multi-Layer Structure]

An oxygen permeability coefficient measuring apparatus (OX-TRAN 2/20: Modern Control Co.) was used. The following method was employed when the sample failed to possess the area of the transmission cell (circle of an area of 50 cm²). A laminate obtained by sticking a biaxially stretched polyethylene terephthalate film of a thickness of 50 μm to an aluminum foil of a thickness of 50 μm was cut into a square of a side of 10 cm, and a hole of a diameter of 25 or 50 mm was perforated in the center. The polyethylene terephthalate film of this laminate was peeled up to the portion of the hole, and a sample to be measured was stuck with a sticking agent so as to close the hole. At this moment, attention was given to a sufficient degree so that no air bubble entered into between the sample to be measured and the sticking agent. Then, the polyethylene terephthalate film that was peeled was carefully placed thereon so that no air bubble was entrapped therein thereby to prepare a holder having the sample to be measured being fitted in the hole. The holder was mounted on the OX-TRAN, and the area of the sample to be measured was corrected thereby to find the amount of oxygen that has permeated through. The amount of oxygen that has permeated through was measured by flowing pure oxygen into the cell on one side and flowing a nitrogen gas (blended with 1% of a hydrogen gas) into another cell under a temperature-humidity condition of 30° C.-80% RH.

[Measurement of Oxygen Permeation Property of the Multi-Layer Container]

The interior of a vacuum gloved box was substituted with a nitrogen gas. Distilled water in an amount of 1 cc was introduced into the multi-layer container in the box, and the opening was heat-sealed with a closure member for olefin having an aluminum foil as a barrier member. The container was boiled in a retort oven under a hydrothermal isobaric condition at 85° C. for 30 minutes and was, then, preserved in an atmosphere of 30° C.-80% RH. The amount of oxygen that has permeated through after one day has passed was measured by using a gas chromatography (GC-3BT: Shimazu Seisakusho Co., detector: TCD (60° C.), column: Molecular Sieve 5A (100° C.), carrier gas: argon).

### Example 1

Ethylene/vinyl alcohol copolymer resin pellets (EP-F101B: Kurare Co.) copolymerized with 32 mol % of ethylene and a cobalt neodecanoate containing 14% by weight of cobalt (DICNATE 5000: Dainihon Ink Kagaku Kogyo Co.) were mixed together in a tumbler, so that the cobalt neodecanoate was homogeneously deposited in an amount of 350 ppm calculated as the amount of cobalt on the surfaces of the ethylene/vinyl alcohol copolymer resin pellets.

Next, by using a biaxial extruder (TEM-35B: Toshiba Kikai Co.) having a strand die mounted on the outlet portion thereof, a maleic anhydride-modified liquid polybutadiene (M-2000-20: Nihon Sekiyu Kagaku Co.) having a number average molecular weight of 5800 and an acid value of 40 KOHmg/g was added dropwise by using a liquid feeder in an amount of 30 parts by weight per 970 parts by weight of the ethylene/vinyl alcohol copolymer resin on which cobalt has been deposited while evacuating to a low degree at a screw rotational speed of 100 rpm. Then, the strands were drawn at a molding temperature of 200° C. to prepare pellets. The pellets had been blended with the maleic anhydride-modified polybutadiene in an amount of 3% by weight.

By using the thus prepared pellets, a three-kind-five-layer parison (LDPE/adhesive/gas barrier layer/adhesive/LDPE) was extruded under the conditions of a shell diameter of 15 mm and a core diameter of 13 mm to prepare a wide-mouth multi-layer bottle of the shape of a jar having a mouth diameter of 44 mm and a volume of 125 cc by the direct blowing method. The resins of the multi-layer bottle were so selected as to possess a weight ratio of LDPE of 92% by weight, adhesive of 4% by weight and gas barrier layer of 4% by weight. The thinnest portion of the multi-layer bottle possessed a thickness of 0.7 mm. The multi-layer structure obtained by cutting the thinnest portion was measured for the diameter of the polyene polymer dispersed particles in cross section of the gas barrier layer in the direction of thickness to find an area average particle diameter of 0.30 μm and an area ratio occupied by the dispersed particles of 3.5%. The amount of oxygen that has permeated through the multi-layer structure was 0.2 cc/m²/day/atom manifesting excellent barrier property.

Further, the multi-layer bottle was boiled, and the amount of oxygen permeation one day after the boiling was measured. As a result, the amount of oxygen that has permeated was 0.02 cc per a bottle. Thus, the multi-layer structure of the invention exhibited excellent gas barrier property even after it was subjected to a severe processing such as boiling.

### Example 2

Pellets were prepared in the same manner as in Example 1 with the exception of adding the maleic anhydride-modified liquid polybutadiene dropwise in an amount of 50 parts by weight per 950 parts by weight of the ethylene/vinyl alcohol copolymer resin to which cobalt has been deposited. The pellets had been blended with the maleic anhydride-modified polybutadiene in an amount of 5% by weight.

By using the thus prepared pellets, a three-kind-five-layer parison (PP/adhesive/gas barrier layer/adhesive/PP) was extruded under the conditions of a shell diameter of 15 mm and a core diameter of 13 mm to prepare a wide-mouth multi-layer bottle of the shape of a jar having a mouth diameter of 44 mm and a volume of 125 cc by the direct blowing method. The resins of the multi-layer bottle were so selected as to possess a weight ratio of PP of 92% by weight, adhesive of 4% by weight and gas barrier layer of 4% by weight. The thinnest portion of the multi-layer bottle possessed a thickness of 0.7 mm. The multi-layer structure obtained by cutting the thinnest portion was measured for the diameter of the polyene polymer dispersed particles in cross section of the gas barrier layer in the direction of thickness to find an area average particle diameter of 0.28 μm and an area ratio occupied by the dispersed particles of 4.9%. The amount of oxygen that has permeated through the multi-layer structure was 0.1 cc/m²/day/atom manifesting excellent barrier property.

Further, the multi-layer bottle was boiled, and the amount of oxygen permeation one day after the boiling was measured. As a result, the amount of oxygen that has permeated was 0.015 cc per a bottle. Thus, the multi-layer structure of the invention exhibited excellent gas barrier property even after it was subjected to a severe processing such as boiling.

### Example 3

A three-kind-five-layer sheet (PP/adhesive/gas barrier layer/adhesive/PP: 550 μm/20 μm/60 μm/20 μm/550 μm) was prepared by using the pellets obtained in Example 2 as a gas barrier layer. By using this multi-layer sheet, a round-shaped cup having an H/D ratio (height/mouth diameter ratio) of 0.8 and a volume of 125 cc was formed by a solid-phase molding method. The thinnest portion of the cup possessed a thickness of 0.36 mm. The multi-layer structure obtained by cutting the thinnest portion was measured for the diameter of the polyene polymer dispersed particles in cross section of the gas barrier layer in the direction of thickness to find an area average particle diameter of 0.27 μm and an area ratio occupied by the dispersed particles of 5.1%. The amount of oxygen that has permeated through the multi-layer structure was 0.2 cc/m²/day/atom manifesting excellent barrier property.

Further, the multi-layer cup was boiled, and the amount of oxygen permeation one day after the boiling was measured. As a result, the amount of oxygen that has permeated was 0.004 cc per a cup. Thus, the multi-layer structure of the invention exhibited excellent gas barrier property even after it was subjected to a severe processing such as boiling.

### Example 4

A multi-layer cup was prepared in the same manner as in Example 3 with the exception of adding the maleic anhydride-modified liquid polybutadiene dropwise in an amount of 10 parts by weight per 990 parts by weight of the ethylene/vinyl alcohol copolymer resin to which cobalt has been deposited. The thinnest portion of the cup possessed a thickness of 0.36 mm. The multi-layer structure obtained by cutting the thinnest portion was measured for the diameter of the polyene polymer dispersed particles in cross section of the gas barrier layer in the direction of thickness to find an area average particle diameter of 0.29 μm and an area ratio occupied by the dispersed particles of 1.0%. The amount of oxygen that has permeated through the multi-layer structure was 1.1 cc/m²/day/atom manifesting excellent barrier property.

Further, the multi-layer cup was boiled, and the amount of oxygen permeation one day after the boiling was measured. As a result, the amount of oxygen that has permeated was 0.02 cc per a cup. Thus, the multi-layer structure of the invention exhibited excellent gas barrier property even after it was subjected to a severe processing such as boiling.

### Example 5

A three-kind-five-layer sheet (PP/adhesive/gas barrier layer/adhesive/PP: 280 μm/10 μm/20 μm/10 μm/280 μm) having a thickness of 0.6 mm was prepared by using the pellets obtained in Example 1 as a gas barrier layer. The multi-layer sheet was cut out and was measured for the diameter of the polyene polymer dispersed particles in cross section in the direction of thickness, i.e., in a direction perpendicular to the direction of drawing to find an area average particle diameter of 0.21 μm and an area ratio occupied by the dispersed particles of 3.1%. A maximum aspect ratio of the dispersed particles was 1.1.

The amount of oxygen that has permeated through the multi-layer structure was 0.2 cc/m²/day/atom manifesting good barrier property.

### Example 6

A three-kind-five-layer sheet (PP/adhesive/gas barrier layer/adhesive/PP: 390 μm/16 μm/23 μm/16 μm/390 μm) having a thickness of 0.84 mm was prepared by using the pellets obtained in Example 1 as a gas barrier layer. The multi-layer sheet was stretched in a direction perpendicular to the direction of drawing to obtain a sheet having a thickness of 0.6 mm. A portion which was evenly stretched was cut out from the sheet and was measured for the diameter of the polyene polymer dispersed particles in cross section in the direction of stretch to find an area average particle diameter of 0.21 μm and an area ratio occupied by the dispersed particles of 3.0%. A maximum aspect ratio of the dispersed particles was 2.0.

The amount of oxygen that has permeated through the multi-layer structure was 0.1 cc/m²/day/atom. Upon increasing the aspect ratio, there was obtained a multi-layer sheet having a barrier property increased to be higher than that of Example 5.

### Example 7

A maleic anhydride-modified liquid polybutadiene having a number average molecular weight of 6300 and an acid value of 20 KOHmg/g was prepared. By using this resin, a multi-layer bottle was prepared in the same manner as in Example 1. The multi-layer structure was obtained by cutting out the thinnest portion of the multi-layer bottle and was measured for the diameter of the polyene polymer dispersed particles in cross section of the gas barrier layer in the direction of thickness to find an area average particle diameter of 1.0 μm and an area ratio occupied by the dispersed particles of 3.3%. The amount of oxygen that has permeated through the multi-layer structure was 0.4 cc/m²/day/atom manifesting excellent barrier property.

Further, the multi-layer bottle was boiled, and the amount of oxygen permeation one day after the boiling was measured. As a result, the amount of oxygen that has permeated was 0.06 cc per a bottle. Thus, the multi-layer structure of the invention exhibited excellent gas barrier property even after it was subjected to a severe processing such as boiling.

### Comparative Examples 1 to 3

Multi-layer structures were prepared under the same conditions as those of Examples 1, 3 and 5 by using, as a gas barrier layer, an ethylene/vinyl alcohol copolymer resin containing neither the polyene polymer nor the transition metal catalyst, and the amounts of oxygen permeation were measured. As a result, the amounts of oxygen that has permeated through the multi-layer structures obtained from a multi-layer bottle, a multi-layer cup and a multi-layer sheet were 4.1 cc/m²/day/atm, 4.8 cc/m²/day/atm and 5.0 cc/m²/day/atm. Thus, the barrier properties were inferior by more than 10 times to those of the multi-layer structures having a gas barrier layer blended with the polyene polymers of Examples 1, 3 and 5.

### Comparative Example 4

A multi-layer bottle was prepared under the same conditions as those of Example 2 by using, as a gas barrier layer, an ethylene/vinyl alcohol copolymer resin containing neither the polyene polymer nor the transition metal catalyst, and a multi-layer structure was obtained in the same manner as in Example 2. The amount of oxygen that has permeated through the multi-layer structure was 4.0 cc/m²/day/atm. Thus, the barrier property was inferior by more than 10 times to that of the multi-layer structure of Example 2.

Further, the multi-layer bottle was boiled, and the amount of oxygen permeation one day after the boiling was measured. As a result, the amount of oxygen that has permeated was 0.26 cc per a bottle. Thus, the oxygen barrier property under the wet heated condition was very inferior to that of the multi-layer bottle of Example 2.

### Comparative Example 5

A multi-layer bottle was prepared in the same manner as in Example 1 with the exception of blending 993 parts by weight of the ethylene/vinyl alcohol copolymer resin with 7 parts by weight of a maleic anhydride-modified liquid polybutadiene (M-2000-20: Nihon Sekiyu Kagaku Co.). A multi-layer structure was obtained by cutting out the thinnest portion of the multi-layer bottle in the same manner as in Example 1 and was measured for the diameter of the polyene polymer dispersed particles in cross section of the gas barrier layer in the direction of thickness to find an area average particle diameter of 0.29 μm and an area ratio occupied by the dispersed particles of 0.7%. The amount of oxygen that has permeated through the multi-layer structure was 2.3 cc/m²/day/atm manifesting poor barrier property.

### Comparative Example 6

A multi-layer bottle was prepared in the same manner as in Example 1 with the exception of using a polybutadiene (B-2000: Nihon Sekiyu Kagaku Co.) instead of using the maleic anhydride-modified liquid polybutadiene. The obtained multi-layer bottle exhibited very rough skin due to defective molding of the gas barrier layer, and exhibited very poor appearance.

A multi-layer structure was obtained by cutting out the thinnest portion of the multi-layer bottle in the same manner as in Example 1 and was measured for the diameter of the polyene polymer dispersed particles in cross section of the gas barrier layer in the direction of thickness to find an area average particle diameter of 1.5 μm and an area ratio occupied by the dispersed particles of 1.5%.

### Comparative Example 7

A multi-layer bottle was prepared in the same manner as in Example 1 with the exception of using a terminal hydroxyl group-modified polyioprene (Poly ip: Idemitsu Sekiyu Kagaku Co.) instead of using the maleic anhydride-modified liquid polybutadiene. In this case, too, the bottle exhibited very rough skin and a very poor appearance like in Comparative Example 6. A multi-layer structure was obtained by cutting out the thinnest portion of the multi-layer bottle in the same manner as in Example 1 and was measured for the diameter of the polyene polymer dispersed particles in cross section of the gas barrier layer in the direction of thickness to find an area average particle diameter of 2.3 μm and an area ratio occupied by the dispersed particles of 1.8%.

The above results are summarized in Table 1.

TABLE 1

| | Oxydizing organic component | | | | | Area |
|---|---|---|---|---|---|---|
| | | Average | Number | | | average |
| | | acid | average | Blending | | particle |
| Ex. & | | value | molecular | amount | | size |
| Comp. Ex. | Kind | (KOHmg/g) | weight | (wt %) | Molded article | (μm) |
| Ex. 1 | maleic anhydride- | 40 | 5800 | 3 | multi-layer bottle | 0.30 |
| | modified | | | | | |
| | polybutadiene | | | | | |
| Ex. 2 | maleic anhydride- | 40 | 5800 | 5 | multi-layer bottle | 0.28 |
| | modified | | | | | |
| | polybutadiene | | | | | |
| Ex. 3 | maleic anhydride- | 40 | 5800 | 5 | multi-layer cup | 0.27 |
| | modified | | | | | |
| | polybutadiene | | | | | |
| Ex. 4 | maleic anhydride- | 40 | 5800 | 1 | multi-layer cup | 0.29 |
| | modified | | | | | |
| | polybutadiene | | | | | |
| Ex. 5 | maleic anhydride- | 40 | 5800 | 3 | multi-layer sheet | 0.21 |
| | modified | | | | | |
| | polybutadiene | | | | | |
| Ex. 6 | maleic anhydride- | 40 | 5800 | 3 | multi-layer sheet | 0.21 |
| | modified | | | | | |
| | polybutadiene | | | | | |
| Ex. 7 | maleic anhydride- | 20 | 6300 | 3 | multi-layer bottle | 1.0 |
| | modified | | | | | |
| | polybutadiene | | | | | |
| Comp. Ex. 1 | — | — | — | — | multi-layer bottle | — |
| Comp. Ex. 2 | — | — | — | — | multi-layer cup | — |
| Comp. Ex. 3 | — | — | — | — | multi-layer sheet | — |
| Comp. Ex. 4 | — | — | — | — | multi-layer bottle | — |
| Comp. Ex. 5 | maleic anhydride- | 40 | 5800 | 0.7 | multi-layer bottle | 0.29 |
| | modified | | | | | |
| | polybutadiene | | | | | |
| Comp. Ex. 6 | polybutadinene | — | could not | 3 | multi-layer bottle | 1.5 |
| | | | be measured | | | |
| Comp. Ex. 7 | terminal OH- | — | could not | 3 | multi-layer bottle | 2.3 |
| | modified | | be measured | | | |
| | Polyisoprene | | | | | |

| | | | O₂ permeation | O₂ permeation | |
|---|---|---|---|---|---|
| | | | amount thru | amount thru | |
| | Area | Max. aspect | multi-layer | multi-layer | |
| Ex. & | ratio | ratio of | structure | container | |
| Comp. Ex. | (%) | particles | (cc/m²/day/atm) | (cc/container) | Remarks |
| Ex. 1 | 3.5 | could not | 0.2 | 0.02 | good barrier property |
| | | be measured | | | |
| Ex. 2 | 4.9 | could not | 0.1 | 0.015 | ″ |
| | | be measured | | | |
| Ex. 3 | 5.1 | could not | 0.2 | 0.004 | ″ |
| | | be measured | | | |
| Ex. 4 | 1.0 | could not | 1.1 | 0.02 | ″ |
| | | be measured | | | |
| Ex. 5 | 3.1 | 1.1 | 0.2 | — | ″ |
| Ex. 6 | 3.0 | 2 | 0.1 | — | Max aspect is 2 or greater and |
| | | | | | barrier property is superior to Ex. 5 |
| Ex. 7 | 3.3 | could not | 0.4 | 0.06 | good barrier property |
| | | be measured | | | |
| Comp. Ex. 1 | — | — | 4.1 | could not be | O₂ permeation is 10 or more times as |
| | | | | measured | great as Ex. 1. |
| Comp. Ex. 2 | — | — | 4.8 | could not be | O₂ permeation is 10 or more times as |
| | | | | measured | great as Ex. 3. |
| Comp. Ex. 3 | — | — | 5.0 | — | O₂ permeation is 10 or more times as |
| | | | | | great as Ex. 5. |
| Comp. Ex. 4 | — | — | 4.0 | 0.26 | O₂ permeation is 10 or more times as |
| | | | | | great as Ex. 2. |
| Comp. Ex. 5 | 0.7 | could not | 2.3 | could not be | O₂ permeation is 10 or more times as |
| | | be measured | | measured | great as Ex. 1. |
| Comp. Ex. 6 | 1.5 | could not | could not be | could not be | Dispersed particles are so coarse |
| | | be measured | measured | measured | that molded bottle exhibits roush |
| | | | | | skin and poor appearance |
| Comp. Ex. 7 | 1.8 | could not | could not be | could not be | Dispersed particles are so coarse |
| | | be measured | measured | measured | that molded bottle exhibits roush |
| | | | | | skin and poor appearance |

According to the present invention, a gas barrier layer is formed by blending a particular gas barrier resin with a transition metal catalyst and an oxidizing organic component, and the dispersion structure and the profile structure of the oxidizing organic component are controlled to lie within particular ranges in cross section of the gas barrier layer in the direction of thickness thereof. Then, it is allowed to markedly improve the oxygen permeation coefficient of the multi-layer structure under the wet heated condition while maintaining excellent workability and mechanical strength.

1. A multi-layer structure having a gas barrier layer with excellent gas barrier property, said gas barrier layer comprising a resin composition obtained by blending a thermoplastic resin having an oxygen permeation coefficient at 20° C. and 0% RH of not larger than 10⁻¹² cc·cm/cm²/sec/cmHg with a transition metal catalyst and an oxidizing organic component, said oxidizing organic component having an average diameter of dispersed particles of not larger than 1 μm as found by an area method in cross section of said gas barrier layer in the direction of thickness thereof, and an area ratio occupied by the dispersed particles being not smaller that 1% in cross section of said gas barrier layer in the direction of thickness thereof.

2. A multi-layer structure according to claim 1, wherein when the direction of thickness of said gas barrier layer is regarded to be a short axis and a direction perpendicular to the direction of thickness is regarded to be a long axis in cross section of said gas barrier layer in the direction of thickness thereof, a maximum value of an aspect ratio of dispersed particles of said oxidizing organic component represented by the length in the long axis direction/length in the short axis direction, is not smaller than 2.

3. A multi-layer structure according to claim 2, wherein said oxidizing organic component is a polyene polymer.

4. A multi-layer structure according to claim 3, wherein said oxidizing organic component is a resin having a functional group.

5. A multi-layer structure according to claim 4, wherein said oxidizing organic component is a resin having a carboxylic acid group or a carboxylic anhydride group.

6. A multi-layer structure according to claim 5, wherein said thermoplastic resin is an ethylene/vinyl alcohol copolymer.

7. A multi-layer structure according to claim 1, wherein said oxidizing organic component is a polyene polymer.

8. A multi-layer structure according to claim 7, wherein said oxidizing organic component is a resin having a functional group.

9. A multi-layer structure according to claim 8, wherein said oxidizing organic component is a resin having a carboxylic acid group or a carboxylic anhydride group.

10. A multi-layer structure according to claim 9, wherein said thermoplastic resin is an ethylene/vinyl alcohol copolymer.

11. A multi-layer structure according to claim 1, wherein said oxidizing organic component is a resin having a functional group.

12. A multi-layer structure according to claim 1, wherein said oxidizing organic component is a resin having a carboxylic acid group or a carboxylic anhydride group.

13. A multi-layer structure according to claim 1, wherein said thermoplastic resin is an ethylene/vinyl alcohol copolymer.

14. A multi-layer structure according to claim 2, wherein said oxidizing organic component is a resin having a functional group.

15. A multi-layer structure according to claim 2, wherein said oxidizing organic component is a resin having a carboxylic acid group or a carboxylic anhydride group.

16. A multi-layer structure according to claim 2, wherein said thermoplastic resin is an ethylene/vinyl alcohol copolymer.
